(19) United States
(12) Patent Application Publication
(10) Pub. No.: US 2004/0120111 A1
(43) Pub. Date: Jun. 24, 2004

(54) Keyboard device

(76) Inventor: Jyh-Tsung Lin, Taipei City (TW)

Correspondence Address: HOFFMANN & BARON, LLP, 6900 JERICHO TURNPIKE, SYOSSET, NY, 11791, US

(21) Appl. No.: 10/323,193

(22) Filed: Dec. 18, 2002

(51) Int. Cl. G06F 1/16

(52) U.S. Cl. 361/686

(57) ABSTRACT

In a keyboard device, multiple key units are assembled on a circuit board unit that includes a wiring board mounted on a substrate and provided with multiple electrical contacts. Each electrical contact is registered with a corresponding through hole in the substrate. In each key unit, a resilient support member has a closed upper portion that abuts against the key cap, and an open lower portion that extends into a corresponding through hole and that abuts against the wiring board. A conducting pad on the support member is spaced apart from the electrical contact in the corresponding through hole when the key cap is at a normal position, and pressing of the key cap results in deforming of the support member such that the conducting pad contacts electrically the electrical contact in the corresponding through hole.

### BACKGROUND OF THE INVENTION

1. Field of the Invention

The invention relates to a keyboard device, more particularly to a keyboard device with key units that are comfortable to operate.

2. Description of the Related Art

FIG. 1 illustrates a conventional keyboard device that includes a circuit board unit 3 and a plurality of key units 4 (only one is shown) assembled on the circuit board unit 3. The circuit board unit 3 includes a substrate 32, and a wiring board 31 mounted on top of the substrate 32 and provided with a plurality of electrical contacts 310 (only one is shown) thereon. Each of the key units 4 includes a foldable retaining member 43 retained on the substrate 32 through a plurality of fasteners that extend through the wiring board 31, a key cap 42 mounted on the retaining member 43 such that the key cap 42 is movable toward and away from the wiring board 31, and a resilient support member 41 disposed between the key cap 42 and the wiring board 31 around a corresponding one of the electrical contacts 310 on the wiring board 31. The resilient support member 41 has a closed upper portion that abuts against the key cap 42, and an open lower portion 411. The upper portion has a bottom surface provided with a conducting pad 412. When the key cap 42 is pressed downwardly by a force (F) acting thereon, the resilient support member is deformed (see FIG. 2) such that the conducting pad 412 of the resilient support member 41 contacts electrically the electrical contact 310 (see FIG. 3).

When reducing the thickness of the conventional keyboard device, the distance between the key cap 42 and the circuit board unit 3 is limited by the extent of deformation of the support member 41 disposed in a limited space may occur. Particularly, if the conventional keyboard device has a thickness equal to (A), and a distance between the conducting pad 412 and the wiring board 31 is equal to B, the relationship between a deformation amount (ΔH) of the support member 41 and the force (F) acting on the key cap 42 is shown in FIG. 4. As shown in FIG. 4, when the deformation amount (ΔH) of the support member 41 is equal to B, the force (F) acting on the key cap 42 is equal to F1. When the extent of deformation is larger, the force (F) required will be greater, thereby resulting in discomfort during operation.

### SUMMARY OF THE INVENTION

Therefore, the object of the present invention is to provide a keyboard device with key units that are comfortable to operate.

According to the present invention, a keyboard device comprises:

a circuit board unit including

a substrate having upper and lower surfaces and formed with a plurality of through holes, each of which extends from the lower surface to the upper surface, and

a wiring board having a mounting surface mounted on the lower surface of the substrate and provided with a plurality of electrical contacts on the mounting surface, each of which is registered with a corresponding one of the through holes; and

a plurality of key units assembled on the circuit board unit, each of the key units including

a foldable retaining member provided on the upper surface of the substrate adjacent to a corresponding one of the through holes,

a key cap mounted on the retaining member such that the key cap is movable toward and away from the upper surface of the substrate, and

a resilient support member disposed between the key cap and the circuit board unit, the resilient support member having a closed upper portion that abuts against the key cap, and an open lower portion that extends into the corresponding one of the through holes and that abuts against the mounting surface of the wiring board, the upper portion having a bottom surface provided with a conducting pad;

the key cap being operable so as to move between a normal position, where the conducting pad of the resilient support member is spaced apart from the electrical contact in the corresponding one of the through holes, and a pressed position, where the key cap is pressed downwardly and the resilient support member is deformed such that the conducting pad of the resilient support member contacts electrically the electrical contact in the corresponding one of the through holes.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary schematic sectional view showing a conventional keyboard device;

FIG. 2 is a fragmentary schematic sectional view showing deformation of a resilient support member of the conventional keyboard device when a key cap is pressed downwardly;

FIG. 3 is a fragmentary schematic sectional view showing deformation of the support member of the conventional keyboard device when the key cap is at a fully pressed position;

FIG. 4 is a plot illustrating the relationship between a force acting on the support member of the conventional keyboard device and a deformation amount in the height of the support member resulting from the force;

FIG. 5 is a fragmentary schematic sectional view showing the preferred embodiment of a keyboard device according to the present invention;

FIG. 6 is a fragmentary schematic sectional view showing deformation of a resilient support member of the preferred embodiment when a key cap is pressed downwardly;

FIG. 7 is a fragmentary schematic sectional view showing deformation of the support member of the preferred embodiment when the key cap is at a fully pressed position; and

FIG. 8 is a plot illustrating the relationship between a force acting on the support member of the preferred embodiment and a deformation amount in the height of the support member resulting from the force.

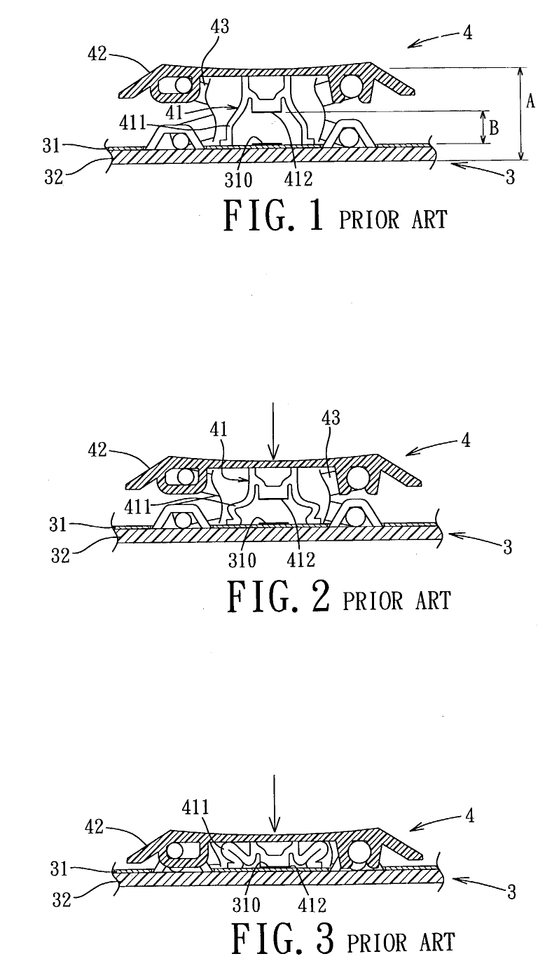

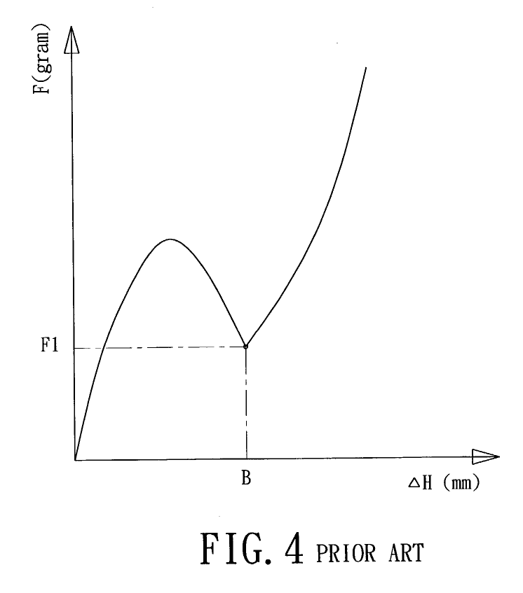

### DETAILED DESCRIPTION OF THE PREFERRED EMBODIMENT

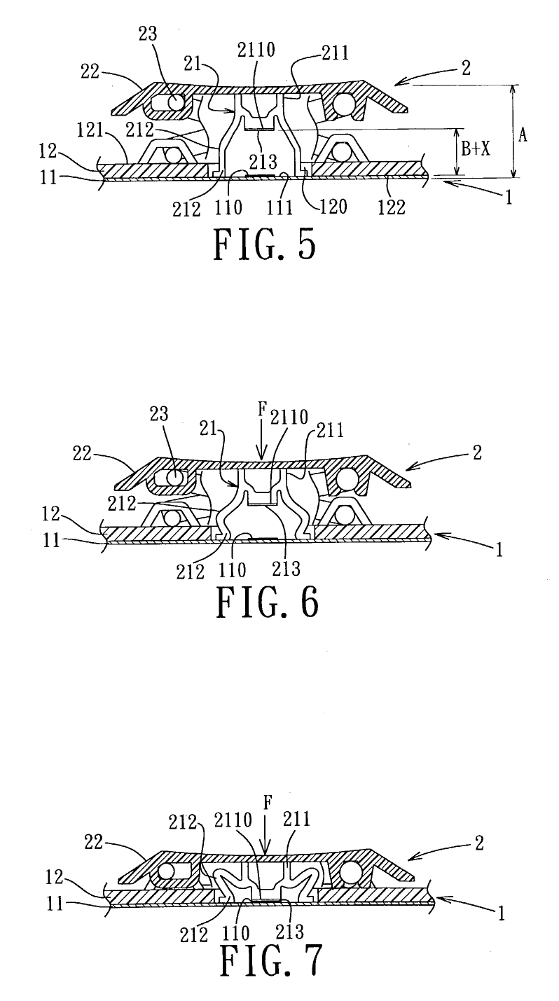

Referring to FIG. 5, the preferred embodiment of a keyboard device according to the present invention is shown to include a circuit board unit 1, and a plurality of key units 2 (only one is shown).

The circuit board unit 1 includes a substrate 12 and a wiring board 11. The substrate 12 has upper and lower surfaces 121, 122, and is formed with a plurality of through holes 120 (only one is shown), each of which extends from the lower surface 122 to the upper surface 121. The wiring board 11 has a mounting surface 111 mounted on the lower surface 122 of the substrate 12, and is provided with a plurality of electrical contacts 110 (only one is shown) on the mounting surface 111. Each of the electrical contacts 110 is registered with a corresponding one of the through holes 120 in the substrate 12.

Each of the key units 2 is assembled on the circuit board unit 1, and includes a foldable retaining member 23, a key cap 22 and a resilient support member 21. The retaining member 23 is provided on the upper surface 121 of the substrate 12 adjacent to a corresponding one of the through holes 120. The key cap 22 is mounted on the retaining member 23 such that the key cap 22 is movable toward and away from the upper surface 121 of the substrate 12. Since the structural connection among the key cap 22, the retaining member 23 and the substrate 12 is known in the art and is irrelevant to the claimed invention, a detailed description of the same is omitted herein for the sake of brevity. The resilient support member 21 is disposed between the key cap 22 and the circuit board unit 1. The resilient support member 21 has a closed upper portion 211 that abuts against the key cap 22, and an open lower portion 212 that extends into and retained in the corresponding one of the through holes 120 and that abuts against the mounting surface 111 of the wiring board 11. The upper portion 211 has a bottom surface 2110 provided with a conducting pad 213.

When the key cap 22 is not pressed, the key cap 22 is disposed at a normal position, where the conducting pad 213 of the resilient support member 21 is spaced apart from the electrical contact 110 in the corresponding one of the through holes 120, as shown in FIG. 5. When the key cap 22 is pressed downwardly by a force (F) acting thereon, the key cap 22 begins to move downwardly toward the substrate 12 from the normal position to a pressed position, where the resilient support member 21 is deformed, as shown in FIG. 6, such that the conducting pad 213 of the resilient support member 21 contacts electrically the electrical contact 110 in the corresponding one of the through holes 120, as shown in FIG. 7.

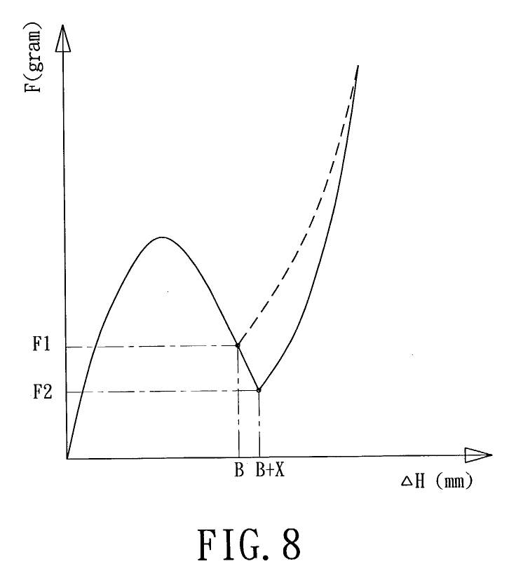

In view of the foregoing, the differences between the keyboard device of this invention and the aforesaid conventional keyboard device reside in that the wiring board 11 is mounted on the lower surface 122 of the substrate 12 and that each of the electrical contacts 110 is disposed in the corresponding one of the through holes 120 in the substrate 12. As such, as shown in FIG. 5, when the key cap 22, the retaining member 23, the substrate 12 and the wiring board 11 have the same specifications, such as thickness, as those of the abovementioned conventional keyboard device such that the keyboard device of this invention has the same thickness (A) as that of the abovementioned conventional keyboard device, the resilient support member 21, which is made of the same material as that in the aforesaid conventional keyboard device, has a larger height than that of the abovementioned conventional keyboard device, i.e., the distance between the conducting pad 213 on the support member 21 and the mounting surface 111 of the wiring board 11 is equal to the distance (B) between the conducting pad 213 and the upper surface 121 of the substrate 12 plus the thickness (X) of the substrate 12. In other words, as a result of the force (F), a deformation amount (AH) of the lower portion 212 of the support member 12 can reach a value of B+X that is greater than that in the aforesaid conventional keyboard device. Referring to FIG. 8, when the conducting pad 213 of the resilient support member 21 contacts electrically the electrical contact 110 in the corresponding one of the through holes 120 (i.e. the deformation amount (ΔH) of the lower portion 212 of the support member 12 is equal to B+X), the force (F) acting on the key cap 22 is equal to F2 that is apparently smaller than the amount (F1) required in the aforesaid conventional keyboard device, thereby resulting in relatively comfortable operation of the keyboard device.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A keyboard device comprising:
a circuit board unit including
a substrate having upper and lower surfaces and formed with a plurality of through holes, each of which extends from said lower surface to said upper surface, and
a wiring board having a mounting surface mounted on said lower surface of said substrate and provided with a plurality of electrical contacts on said mounting surface, each of which is registered with a corresponding one of said through holes; and
a plurality of key units assembled on said circuit board unit, each of said key units including
a foldable retaining member provided on said upper surface of said substrate adjacent to a corresponding one of said through holes,
a key cap mounted on said retaining member such that said key cap is movable toward and away from said upper surface of said substrate, and
a resilient support member disposed between said key cap and said circuit board unit, said resilient support member having a closed upper portion that abuts against said key cap, and an open lower portion that extends into the corresponding one of said through holes and that abuts against said mounting surface of said wiring board, said upper portion having a bottom surface provided with a conducting pad;
said key cap being operable so as to move between a normal position, where said conducting pad of said resilient support member is spaced apart from said electrical contact in the corresponding one of said through holes, and a pressed position, where said key cap is pressed downwardly and said resilient support member is deformed such that said conducting pad of said resilient support member contacts electrically said electrical contact in the corresponding one of said through holes.
